(19) United States
(12) Patent Application Publication
(10) Pub. No.: US 2005/0045570 A1
(43) Pub. Date: Mar. 3, 2005

(54) Table base and method for making the same

(76) Inventor: Ted Oberg, New South Wales (AU)

Correspondence Address: D. PETER HOCHBERG CO. L.P.A., 1940 EAST 6TH STREET, CLEVELAND, OH, 44114, US

(21) Appl. No.: 10/493,124

(22) PCT Filed: Oct. 8, 2002
(86) PCT No.: PCT/AU02/01366

(30) Foreign Application Priority Data
Oct. 19, 2001 (AU) PR8392

(51) Int. Cl. A47F 7/00; C03B 21/00; C03C 15/00

(52) U.S. Cl. 211/27; 65/30.14; 65/107

(57) ABSTRACT

An all glass table is disclosed. The table includes a base formed from a single sheet of glass for a table. The base has a series of height downwardly depending legs a generally planar central portion and a series of height upwardly extending arms. A table top comprising a sheet of glass is supported on the upper ends of the arms. The table is made by a glass slumping process on a mould. The mould has a central portion, a series of eight legs depending down from the central portion and a series of members extending upwardly relative to the central portion. A sheet of glass cut to a generally flower or corolla shape defining petals is placed on top of the mould with the outer parts of some of the petals of the sheet of glass resting on upper portions of the upwardly extending members and other petals located above the legs of the mould. The glass is then heated to cause the sheet of glass to slump and approximate to the shape of the mould. The glass is then toughened in a salt bath or the like.

### FIELD OF THE INVENTION

This invention relates to a table base and to a method of making a table base or similar structure by glass slumping.

### BACKGROUND OF THE INVENTION

It is known to slump glass by placing a sheet of glass on top of a mould in a kiln, and heating the glass so that the sheet of glass loses its rigidity and softens and slumps over the mould, thus acquiring the shape of the mould. It is known to make a number of different glass objects using this method, such as small coffee tables and the like. U.S. Pat. No. 6,257,022 discloses a method of making a lamp shade by a glass slumping method. However, design reasons and the limitations of the existing slumping methods place limitations on this process and it is not currently possible for example, to satisfactorily manufacture large all glass tables such as dining tables using this method, because using glass slumping, the legs for supporting a table tend to extend around and depend from the perimeter of the table top and this prevents the design of a satisfactory table having enough leg room for satisfactory use.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

### SUMMARY OF THE INVENTION

In a first aspect of the present invention there is provided a method of slumping glass comprising the steps of:
providing a mould for use in a glass slumping process, the mould defining a central portion which is typically generally planar, and a series of legs depending down from the central portion, the mould being characterised by a series of members extending upwardly relative to the central portion, the method being further characterised by the step of placing a sheet of glass cut to a generally flower or corolla shape defining petals on top of the mould with parts of some of the petals of the sheet of glass resting on upper portions of the upwardly extending members and other petals located above the legs of the mould; and
heating the mould and the glass to cause the sheet of glass to slump and approximate to the shape of the mould.

In a preferred embodiment, the resultant slumped glass structure is then chemically toughened by heating it in a salt bath at high temperatures for a number of hours, typically thirty hours.

The present invention also provides a base formed from a single sheet of glass for a table comprising:
a series of downwardly depending legs;
a central portion;
a series of upwardly extending arms adapted to receive a sheet of glass or the like resting thereon.

An all glass table can then be formed by placing a glass table top on top of the upper (distal) ends of the arms.

### BRIEF DESCRIPTION OF THE DRAWINGS

A specific embodiment of the invention will now be described by way of example only, and with reference to the accompanying drawings in which:

FIG. 1 is a perspective view of a flat sheet of glass cut into a flower pattern resting on top of a mould before slumping;

FIG. 2 is a plan view of the mould and glass shown in FIG. 1;

FIG. 3 is a perspective view of the glass shown in FIG. 1 after the glass has been slumped to the shape of the mould; and

FIG. 4 shows the slumped sheet of glass of FIG. 3 separated from the mould.

### DETAILED DESCRIPTION OF PREFERRED EMBODIMENT

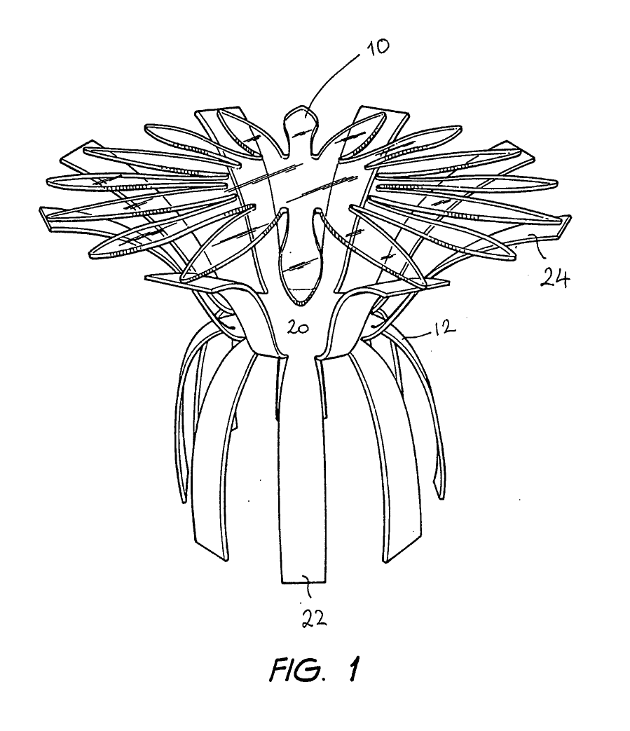

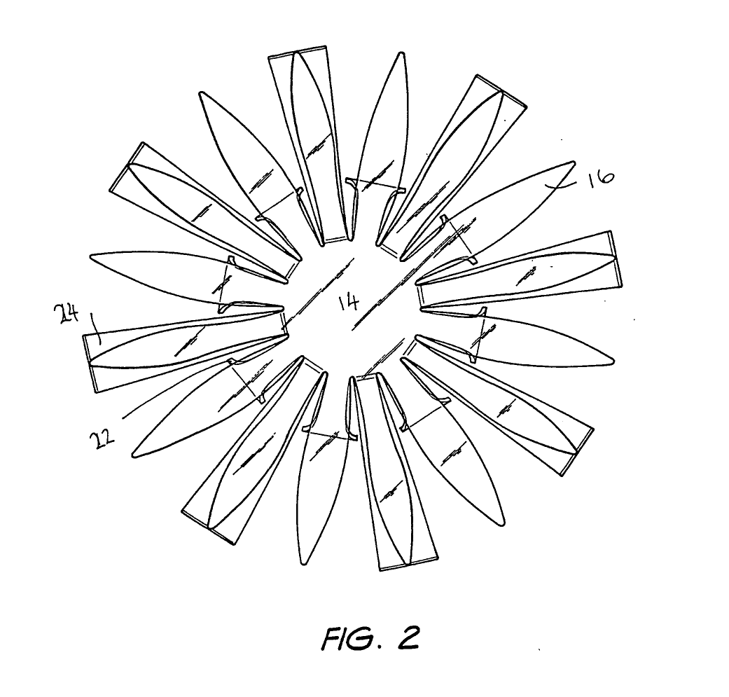

Referring to the drawings, FIG. 1 shows a perspective view of a sheet of glass 10 resting on top of a mould 12. As can be seen in both FIGS. 1 and 2, a sheet of glass has been cut into a flower pattern or corolla using a water jet to define a central portion 14 and a series of sixteen petals 16 extending away from the central portion. The tips of the petals are pointed, although the shape and number of petals may be changed from that illustrated.

The sheet of glass 10 rests on a mould which is typically made of steel. As is best shown in FIG. 1, the mould defines a central portion 20 supported by a series of eight spaced apart depending generally curved legs 22. Between each pair of depending legs, there is a generally S-shaped upwardly extending arm portion 24 each portion defining a convex and a concave portion.

As shown in FIG. 1, the tips of every second petal 16 rests on the end of one of the arm portions 24 with the remaining petals being unsupported and resting in mid-air above one of the depending leg portions 22.

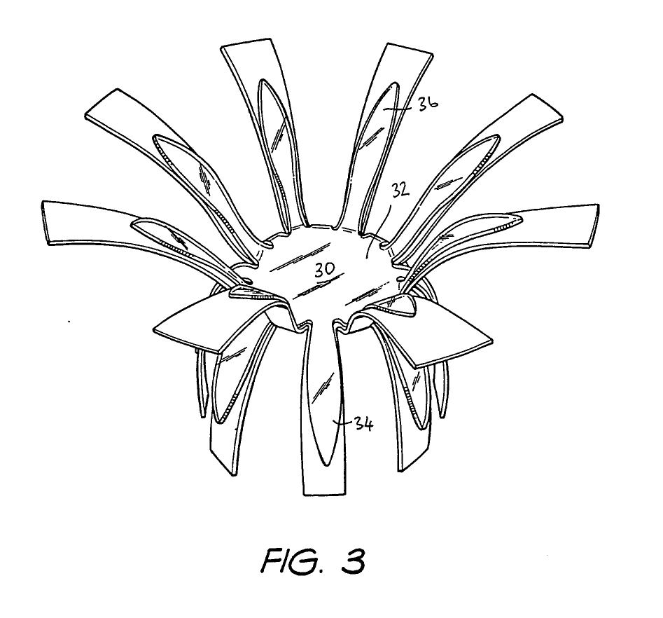

When the assembly is placed in a kiln and the temperature raised to about 600 to 700 degrees Centigrade, the glass sheet softens, slumps to form a structure 28 which approximates to the shape of the mould as illustrated in FIG. 3. The top part of the mould captures every second petal and the other petals drop through the gaps between the arm portions 24 and acquire the shape of the depending leg portions 22 disposed between the upstanding arm portions 24. The resultant glass structure 30 has a central area 32, a series of eight depending legs 34 and a series of eight upstanding arms 36.

Thus, the present invention enables the provision of glass structures in which sheets of glass appear to be slumped in two different opposed directions at once which the skilled person in the art would ordinarily think would not be possible.

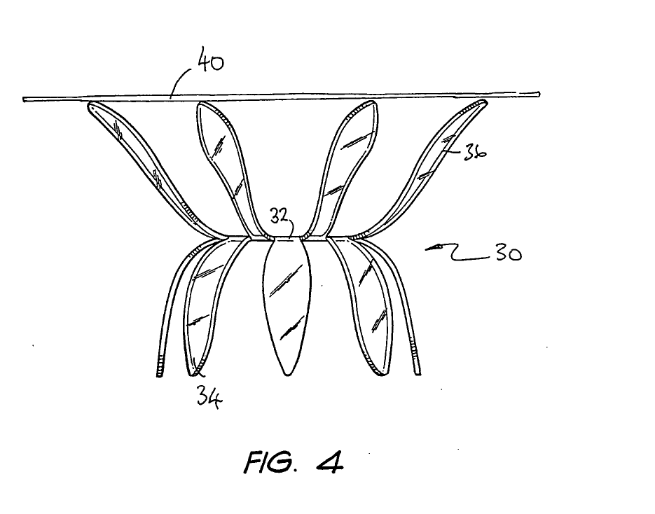

FIG. 4 shows the cooled slumped glass structure 28 removed from the mould and used to support a circular glass top 40 thereby forming an all glass table which, by using the slumped glass form as a support, can provide sufficient leg room to users for the table to be satisfactorily used as a dining table or the like.

The slumped glass form is thermally toughened to strengthen the glass by standing in a salt bath for typically around thirty hours. Such glass toughening techniques are well known in the art. Australian patents No 101964 and 101965 to Corming Glass Works disclose glass toughening methods. The particular toughening method used is not critical to the invention.

It will be clear to the person skilled in the art that a table support or structure having fewer or greater number of legs and arms than those shown in the drawings, is possible. It would also be clear to the person skilled in the art that it is not necessary for the table to have as many arms as legs and that the table base can be made relatively larger or smaller without deviating from the principals of the present invention. It will also be clear to the person skilled in the art.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-6. (Canceled)

7. A method of slumping glass comprising the steps of:
providing a mould for use in a glass slumping process, the mould defining:
a central portion;
a plurality of legs depending down from the central portion; and
a plurality of support members extending upwardly relative to the central portion,
the support members having upper end portions distal from the central portion;
the method further including the steps of:
taking a sheet of glass defining a central part and a series of petal-like elements extending away from the central part;
placing said sheet of glass on the mould with parts of some of the petals of the sheet of glass resting on the upper portions of the upwardly extending members and with others of the petals located above the legs of the mould; and
heating the glass to cause the sheet of glass to slump and approximate to the shape of the mould.

8. A method of slumping glass as claimed in claim 7 wherein the mould defines at least six legs and six members.

9. A method of slumping glass as claimed in claim 7 wherein the members are generally S shaped defining a convex and a concave portion.

10. A method of slumping glass as claimed in claim 7 wherein the central portion of the mould is generally planar.

11. A method of slumping glass as claimed in claim 7 wherein the resultant slumped glass structure is chemically toughened by heating it in a salt bath at high temperatures for a number of hours.

12. A glass table support formed from a single sheet of glass, the table support having a plurality of table legs, a central portion supported by said legs, and a series of support arms extending upwardly from the central portion and defining ends distal from the central portion for supporting a table top.

13. A glass table support as claimed in claim 12 wherein the support members define a convex and a concave portion.

14. A glass table support as claimed in claim 12 wherein each table leg is between and adjacent two support arms.

15. A glass table comprising a glass table support formed from a single sheet of glass, the table support having a plurality of table legs, a central portion supported by said legs, and a series of support arms extending upwardly form the central portion and defining ends distal from the central portion for supporting a table top and a glass top supported on said ends of said support arms.

16. A glass table as claimed in claim 15 wherein the support members define a convex and a concave portion.

17. A glass table as claimed in claim 15 wherein each table leg is between and adjacent two support arms.
